(19) United States
(12) Patent Application Publication
(10) Pub. No.: US 2009/0190981 A1
(43) Pub. Date: Jul. 30, 2009

(54) TRANSFER MATERIAL SEPARATING DEVICE, TRANSFER DEVICE AND IMAGE FORMING APPARATUS

(75) Inventor: Shinichi TANAKA, Shiojiri-shi (JP)

Correspondence Address: HOGAN & HARTSON L.L.P., 1999 AVENUE OF THE STARS, SUITE 1400, LOS ANGELES, CA, 90067, US

(73) Assignee: SEIKO EPSON CORPORATION, Tokyo (JP)

(21) Appl. No.: 12/360,550

(22) Filed: Jan. 27, 2009

(30) Foreign Application Priority Data
Jan. 28, 2008 (JP) 2008-016084
Oct. 6, 2008 (JP) 2008-259490

(51) Int. Cl. G03G 15/00

(52) U.S. Cl. 399/397

(57) ABSTRACT

A transfer material separating device includes a transfer material separation air blower unit configured to blow air to a transfer material moving together with a transfer material moving member and separate the transfer material from the transfer material moving member, in which the transfer material separation air blower unit includes a first blowing unit configured to blow air toward a center portion of the transfer material in the direction orthogonal or substantially orthogonal to the direction of movement of the transfer material, and a second blowing unit configured to blow air in the direction substantially orthogonal to the direction of movement of the transfer material to side portions of the transfer material in the direction orthogonal or substantially orthogonal to the direction of movement of the transfer material.

### BACKGROUND

1. Technical Field

In image forming apparatuses of an electrophotographic system such as copying machines, facsimile machines, or printers using liquid developer (liquid toner), the present invention relates to a transfer material separating device that separates a transfer material to which a liquid developer image is transferred from a transfer material moving member, a transfer device that transfers the liquid developer image to the transfer material, and an image forming apparatus.

2. Related Art

In general, in an image forming apparatus using liquid developer (liquid toner), through pressure contact of a transfer material against a transfer medium in the transfer device and movement of the transfer material with the transfer medium, the liquid developer image is transferred to the transfer material. Also, through the press contact of the transfer material to which the liquid developer image is transferred against a fixing member of a fixing device, and movement of the transfer material with the fixing medium, the liquid developer image is fixed to the transfer material.

In this case, a transfer surface of the transfer material on the side of the liquid developer image is brought into press contact with the transfer material moving member such as the transfer medium or the fixing member. In this manner, when the transfer surface of the transfer material is brought into press contact with the transfer material moving member, the transfer material easily sticks to the transfer material moving member due to the nature specific to the liquid developer. Therefore, the transfer material to which the liquid developer image is transferred can hardly be separated from the transfer material moving member. Therefore, in the related art, an image forming apparatus having a transfer material separating device which is adapted to separate a distal end portion of the transfer material forcedly from the transfer material moving member by blowing air to the distal end of the transfer material which is transported together with the transfer material moving member is proposed (for example, Japanese Patent No. 3128067).

The transfer material separating device disclosed in Japanese Patent No. 3128067 is adapted to separate the distal end portion of the transfer material by causing the blown air to enter between the distal end of the transfer material and the transfer material moving member.

In the transfer material separating device disclosed in Japanese Patent No. 3128067 described above, air is simply blown onto the distal end of the transfer material during the image forming operation. Therefore, separation of the transfer material is not necessarily achieved effectively.

### SUMMARY

An advantage of some aspects of the invention is to provide a transfer material separating device, a transfer device and an image forming apparatus, which are able to achieve separation of a transfer material using air more efficiently.

In a transfer material separating device, a transfer device, and an image forming apparatus according to aspects of the invention, an airflow is generated by a transfer material separation air blower unit and is blown toward the transfer material. In this case, the airflow is blown from a first blowing unit in the direction of movement of the transfer material at a center portion of the transfer material in the direction orthogonal or substantially orthogonal to the direction of movement of the transfer material. The airflow is blown from a second blowing unit in the direction substantially orthogonal to the direction of movement of the transfer material on a side portion of the transfer material in the direction orthogonal or substantially orthogonal to the direction of movement of the transfer material. In other words, the airflow is blown toward the distal end of the transfer material in two different directions.

Alternatively, the airflow is blown from the first blowing unit in the direction orthogonal or substantially orthogonal to the direction of movement of the transfer material and the plane of the transfer material at the center portion of the transfer material in the direction orthogonal or substantially orthogonal to the direction of movement of the transfer material. In both side portions of the transfer material in the direction orthogonal or substantially orthogonal to the direction of movement of the transfer material, the airflow is blown from the second blowing unit and a third blowing unit in the direction of movement of the transfer material, in the direction orthogonal or substantially orthogonal to the direction of movement of the transfer material within the plane of the transfer material, and in the direction orthogonal or substantially orthogonal to the plane of the transfer material. In other words, the air is blown toward the distal end of the transfer material in three different directions. Therefore, since the center of the distal end of the transfer material is separated and the sides of the distal end of the transfer material are separated by blowing the air in the two directions or three directions, the transfer material is effectively separated.

In this case, by separating reliably the transfer material at the center portion described above of the transfer material, the strong airflow is allowed to enter a gap between the separated transfer material at the center portion and the transfer material moving member which is the liquid developer image carrier member such as the transfer medium or the electrostatic latent image carrier member. Then, since the air entered into the gap at the center portion can hardly be leaked out, the distal end portion of the transfer material can be separated effectively from the transfer material moving member from the center portion toward the both side portions.

Since a weak air is blown to the transfer material in the direction substantially orthogonal to the direction of movement of the transfer material at the both side portions of the transfer material orthogonal or substantially orthogonal to the direction of movement of the transfer material, the transfer material is efficiently and economically led in the direction away from the transfer material moving member. Accordingly, the transfer material is effectively separated from the transfer material moving member.

In particular, an airflow control valve is disposed in an airflow duct of the transfer material separation air blower unit. With this airflow control valve, stable blowing of air to the distal end of the transfer material at a predetermined flow rate is achieved when starting the blow of the air. Accordingly, separation of the distal end of the transfer material by the blowing of the air is achieved further reliably and efficiently.

In the both side portions of the transfer material in the direction orthogonal or substantially orthogonal to the direction of movement of the transfer material, the air is blown from the second and third blowing units toward the distal end of the transfer material in the direction of the movement of the transfer material, in the direction orthogonal or substantially orthogonal to the direction of movement of the transfer material within the plane of the transfer material, and in the direction orthogonal or substantially orthogonal to the plane of the transfer material. Accordingly, the center portion of the distal end of the transfer material in the direction orthogonal or substantially orthogonal to the direction of movement of the transfer material within the plane of the transfer material is separated, for example, by a strong airflow from the first blowing unit from the direction of movement of the transfer material.

Then, when the center portion of the transfer material is separated once, even when the blowing of the strong airflow from the first blowing unit is stopped, for example, the weak airflow in the three directions as described above blown from the second blowing unit and the third blowing unit enables effective separation of the distal end portion of the transfer material from the direction of movement of the transfer material. In addition, when the center portion of the distal end portion of the transfer material is separated once, blowing of the strong airflow from the first blowing unit is stopped, and hence an image formed at the center portion of the transfer material in relatively many cases is prevented effectively from being affected by the air blown onto the center portion.

In this manner, by differentiating the direction of blowing air to the transfer material, even the transfer material which can hardly be separated is reliably separated from the transfer material moving member. Therefore, the transfer material is prevented from moving with the transfer material moving member, and hence the transfer material is reliably moved toward the next transfer position.

### BRIEF DESCRIPTION OF THE DRAWINGS

The invention will be described with reference to the accompanying drawings, wherein like numbers reference like elements.

FIG. 1 is a drawing showing an image forming apparatus having a transfer material separating device according to a first example in an embodiment of the invention schematically and partly.

FIG. 2 is a general perspective view of the transfer material separating device in the first example.

FIG. 3 is a top view of the transfer material separating device in the first example.

FIG. 4A corresponds to a portion IV in FIG. 1, and is a cross-sectional view of a first duct.

FIG. 4B corresponds to the portion IV in FIG. 1, and is a cross-sectional view of second and third ducts.

FIG. 5A is a cross-sectional view showing a part of FIG. 4A in an enlarged scale.

FIG. 5B is a cross-sectional view showing a part of FIG. 4B in an enlarged scale.

FIG. 6 is a drawing showing the image forming apparatus according to a second example in the embodiment of the invention schematically and partly.

FIG. 7 is a cross-sectional view of a transfer material separating air device in the second example.

FIG. 8 is a drawing showing the image forming apparatus according to a third example in the embodiment of the invention schematically and partly.

FIG. 9 is a perspective view of a transfer material separating air device used in the image forming apparatus according to a fourth example in the embodiment of the invention.

### DESCRIPTION OF EXEMPLARY EMBODIMENTS

Referring now to the drawings, best modes for carrying out the invention will be described.

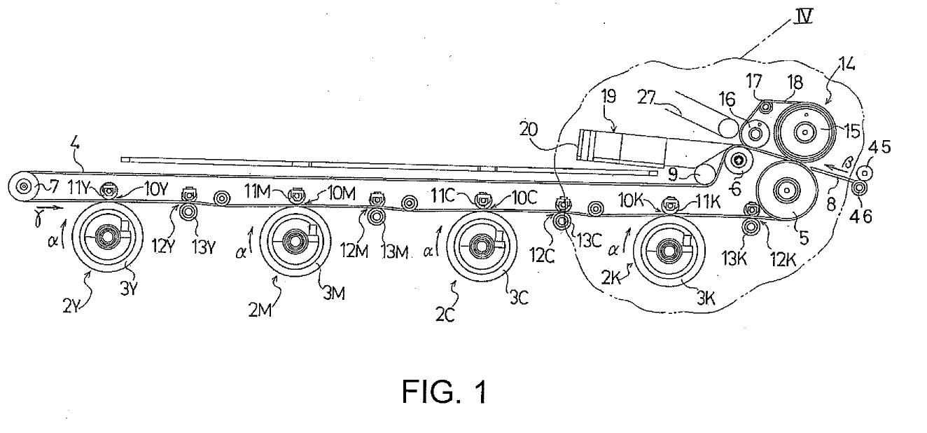

FIG. 1 is a drawing showing an image forming apparatus having a transfer material separating device according to a first example in an embodiment of the invention schematically and partly.

As shown in FIG. 1, an image forming apparatus 1 in the first example includes image forming units 2Y, 2M, 2C, and 2K using liquid developer in colors of yellow (Y), magenta (M), cyan (C), and black (K) arranged in tandem. In the respective image forming units 2Y, 2M, 2C, and 2K, 2Y represent a yellow image forming unit, 2M represents a magenta image forming unit, 2C represents a cyan image forming unit, and 2K represents a black image forming unit. Other color members are also represented by adding letters Y, M, C, and K for the respective colors to reference numerals of the members.

The respective image forming units 2Y, 2M, 2C, and 2K include photoconductors 3Y, 3M, 3C, and 3K as latent image carrier members, respectively. In the first example shown in FIG. 1, the respective photoconductors 3Y, 3M, 3C, and 3K are formed of a photoconductor drum. The respective photoconductors 3Y, 3M, 3C, and 3K may be configured in the form of an endless belt.

The photoconductors 3Y, 3M, 3C, and 3K are adapted to rotate clockwise as shown by an arrow α in FIG. 1 when being operated. Although not shown in the drawing, the image forming units 2Y, 2M, 2C, and 2K each include a charged member, an exposing device, a liquid developing device, a photoconductor squeezing device, a dielectrifying device, and a photoconductor cleaning device, arranged around the each of the photoconductors 3Y, 3M, 3C, and 3K like the known image forming apparatuses employing the liquid developer in the related art. The charged member, the exposing device, the liquid developing device, the photoconductor squeezing device, the dielectrifying device, and the photoconductor cleaning device are arranged in this order in the direction of rotation of the respective photoconductors 3Y, 3M, 3C, and 3K. The respective photoconductors 3Y, 3M, 3C, and 3K are formed with electrostatic latent images in corresponding colors, and the respective electrostatic latent images are developed with liquid developer in the respective colors, so that toner images are formed.

As shown in FIG. 1, the image forming apparatus 1 includes an endless intermediate transfer belt 4 as a transfer medium. The transfer medium may be a transfer roller. In the following description, the transfer medium is described as the intermediate transfer belt 4.

The intermediate transfer belt 4 is wound around a belt driving roller 5 to which a drive force from a motor, not shown, is transmitted, and a pair of driven rollers 6 and 7 with tension. In this case, the belt driving roller 5 and the one driven roller 6 are arranged adjacently at a predetermined distance from each other in the direction of movement of a transfer material 8 shown by an arrow β of the transfer material such as paper transported to a secondary transfer device 14, described later. The belt driving roller 5 and the other driven roller 7 are arranged along the direction of tandem arrangement of the respective photoconductors 3Y, 3M, 3C, and 3K at a distance from each other. Besides, the intermediate transfer belt 4 is applied a predetermined tension by a tension roller 9. Then, the intermediate transfer belt 4 is provided so as to be rotated by the belt driving roller 5 counterclockwise indicated by an arrow γ in FIG. 1.

In the image forming apparatus 1 in the first example, the image forming units 2Y, 2M, 2C, and 2K are arranged in the order of Y, M, C, and K in color from the upstream side in the direction of rotation γ of the intermediate transfer belt 4 (left side in FIG. 1). However, the order of arrangement of the respective colors Y, M, C, and K may be set as desired.

Around the respective photoconductors 3Y, 3M, SC, and 3K, primary transfer devices 10Y, 10M, 10C, and 10K are disposed, respectively. The primary transfer devices 10Y, 10M, 10C, and 10K each are arranged between the photoconductor squeezing device, not shown, and the dielectrifying device. The primary transfer devices 10Y, 10M, 10C, and 10K include backup rollers 11Y, 11M, 11C, and 11K for primary transfer, respectively. The backup rollers 11Y, 11M, 11C, and 11K bring the intermediate transfer belt 4 into press contact with the respective photoconductors 3Y, 3M, 3C, and 3K.

The backup rollers 11Y, 11M, 11C, and 11K are each applied an electric charge of an opposite polarity from the charged polarity of toner particles, whereby respective toner images on the respective photoconductors 3Y, 3M, 3C, and 3K are transferred to the intermediate transfer belt 4. In this case, a yellow (Y) toner image is transferred to the intermediate transfer belt 4 first, then, a magenta (M) tonner image is transferred thereto so as to be superimposed on the yellow (Y) toner image. From then on, a cyan (C) toner image and a black (K) toner image are transferred in this order onto the intermediate transfer belt 4 so as to be superimposed on the previously transferred image, so that a full color toner image is formed on the intermediate transfer belt 4.

Intermediate transfer belt squeezing devices 12Y, 12M, 12C, and 12K are disposed in the vicinity of the respective primary transfer devices 10Y, 10M, 10C, and 10K on the downstream side of the primary transfer devices 10Y, 10M, 10C, and 10K in the direction of rotation γ of the intermediate transfer belt 4. The respective intermediate transfer belt squeezing devices 12Y, 12M, 12C, and 12K include intermediate transfer belt squeeze rollers 13Y, 13M, 13C, and 13K, respectively. The respective intermediate transfer belt squeeze rollers 13Y, 13M, 13C, and 13K collect carrier liquid of corresponding colors on the intermediate transfer belt 4.

Then, the secondary transfer device 14 is provided on the intermediate transfer belt 4 on the side of the belt driving roller 5. The secondary transfer device 14 includes a pair of rollers 15 and 16 arranged at a predetermined distance from each other in the direction of movement of the transfer material β, a roller 17 arranged in the direction substantially orthogonal to the direction of movement of the transfer material β with respect to the roller 16, and a transfer belt 18 wound around the three rollers 15, 16, and 17. The roller 15 on the upstream side in the direction of movement of the transfer material β is arranged so as to oppose the belt driving roller 5, and brings the transfer belt 18 into press contact with the intermediate transfer belt 4 wound around the belt driving roller 5. The roller 16 on the downstream side in the direction of movement of the transfer material β is arranged so as to oppose the driven roller 6 and brings the transfer belt 18 into press contact with the intermediate transfer belt 4 wound around the driven roller 6. Then, the toner image (liquid developer image) on the intermediate transfer belt 4 is transferred to the transfer material 8 while the transfer material 8 is nipped between transfer nip portions between the transfer belt 18 between the two rollers 15 and 16 and the intermediate transfer belt 4 between the belt driving roller 5 and the driven roller 6, and is moved in the direction of movement of the transfer material β. Therefore, the intermediate transfer belt 4 also constitutes a transfer material moving member and a liquid developer image carrier member in the embodiments of the invention.

Reference numerals 45 and 46 designate a pair of resist rollers for transporting the transfer material 8 from a transfer material storage device, not shown, for storing the transfer material 8 to a secondary transfer device 14, which is known in the related art. The image forming apparatus 1 includes a fixing device and a transfer material discharging tray from the secondary transfer device 14 in the direction of transport (direction of movement) of the transfer material. FIG. 1 shows part of a transfer material belt carrier device 27 for transporting the transfer material 8 from the secondary transfer device 14 to the fixing device.

As shown in FIG. 1, the secondary transfer device 14 includes a transfer material separating device 19 provided adjacently to a terminal of the transfer nip portion and a guide member 47 for guiding the transfer material 8 moved from the transfer nip portion toward the transfer material belt carrier device 27. The transfer material separating device 19 includes a transfer material separating air device 20 (which corresponds to a transfer material separation air blower unit in the invention) for blowing air to a separating position 4a at which the transfer material 8 is separated from the intermediate transfer belt 4. The transfer material separating air device 20 may employ a air blowing device for blowing air other than air. In the following description, the transfer material separating air device 20 is used.

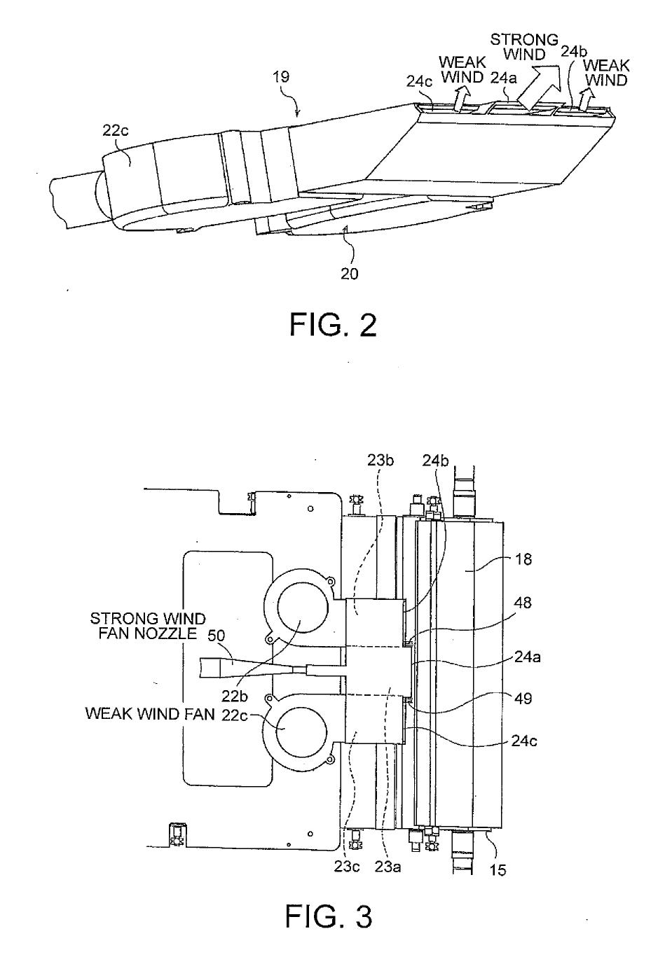

As shown in FIG. 2 and FIG. 3, the transfer material separating air device 20 includes a first duct 23a positioned at a center and second and third ducts 23b and 23c positioned on both sides of the first duct 23a. The first to third ducts 23a, 23b, and 23c respectively include first to third air blowing ports 24a, 24b, and 24c provided respectively at the distal ends thereof. In this case, the first air duct 23a and the first air blowing port 24a constitute a first blowing unit in this example. The second duct 23b and the second air blowing port 24b constitute a second blowing unit, in this example. The third duct 23c and the third air blowing port 24c constitute a third blowing unit, in this example. A first airflow separating member 48 is provided between the first and second air blowing ports 24a and 24b. The first airflow separating member 48 is adapted to separate air blown from the first air blowing port 24a and air blown from the second air blowing port 24b reliably. On the other hand, a second airflow separating member 49 is provided between the first and third air blowing ports 24a and 24c. The second airflow separating member 49 is adapted to separate air blown from the first air blowing port 24a and air blown from the third air blowing port 24c reliably. The first and second airflow separating members 48 and 49 are formed of a resin brush or a resin film.

The first duct 23a is connected to a first air fan, not shown, which generates a strong airflow via a strong wind fan nozzle 50. The second and third ducts 23b and 23c are connected to second and third air fans 22b and 22c which generate airflows weaker than the airflow generated by the first air fan, respectively.

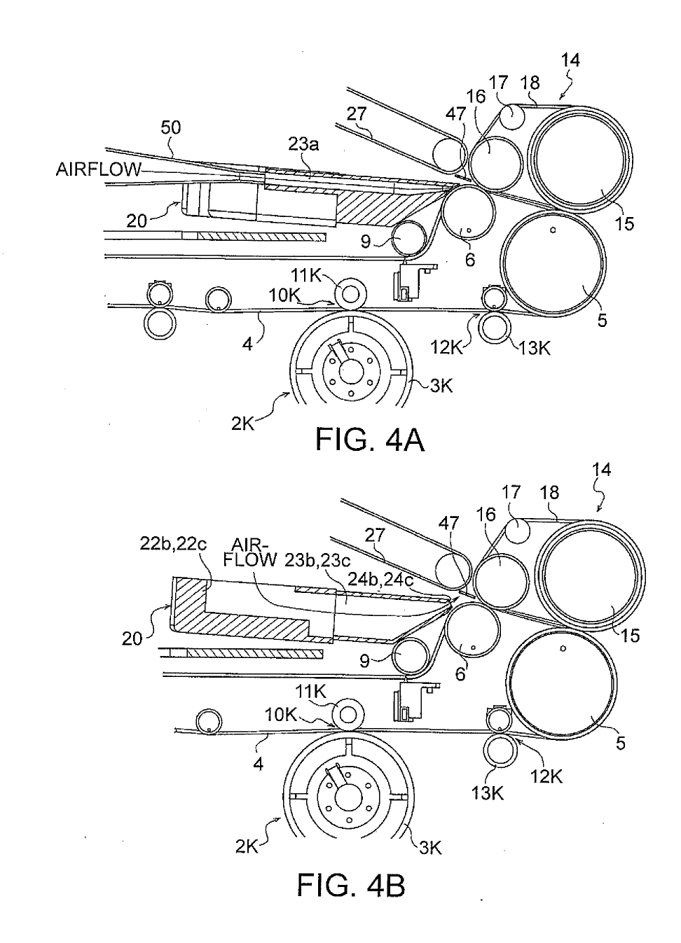

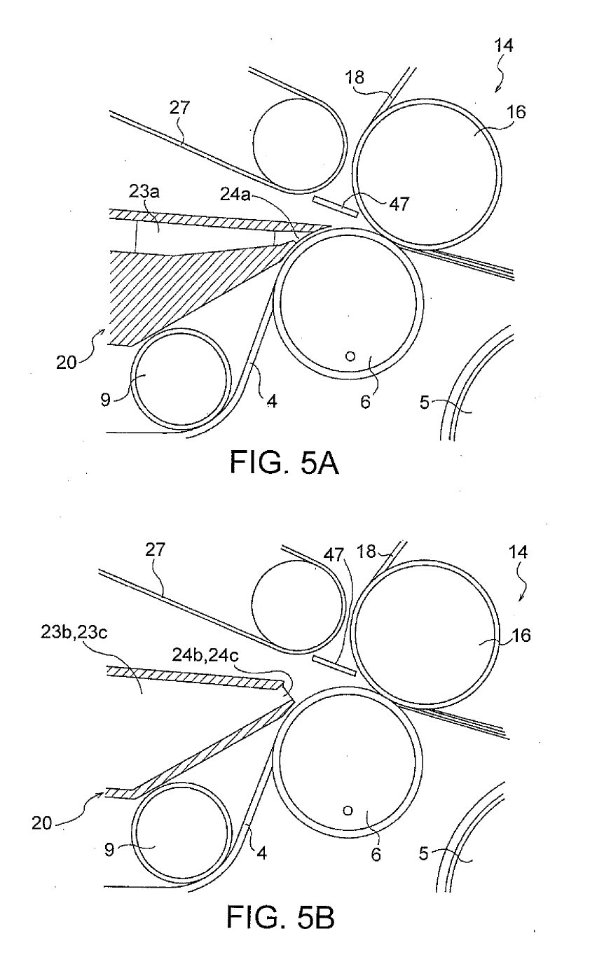

As shown in FIG. 4A, the flow channel area of the first duct 23a is set to be relatively small. As shown in FIG. 5A in an enlarged scale, the first air blowing port 24a of the first duct 23a is provided so as to be directed toward the separating position 4a (the direction substantially of a tangent line at the separating position 4a of the intermediate transfer belt 4 wound around the driven roller 6 and curved into an arcuate shape).

In contrast, as shown in FIG. 4B, the areas of the respective flow channels of the second and third ducts 23b and 23c are set to be larger than that of the first duct 23a. As shown in FIG. 5B in an enlarged scale, the second and third air blowing ports 24b and 24c of the second and third ducts 23b and 23c are provided so as to be directed in the direction substantially orthogonal to the guide member 47. In this manner, the direction of the first air blowing port 24a and the directions of the second and third air blowing ports 24b and 24c are different.

Therefore, a high-flow-rate air (strong wind) is blown from the first air blowing port 24a toward the separating position 4a. In other words, the high-flow-rate air (strong wind) is blown from the first air blowing port 24a so as to enter between a distal end of the transfer material 8 and the intermediate transfer belt 4 at a center portion of the distal end of the transfer material in the direction orthogonal or substantially orthogonal to the direction of movement of the transfer material. A low-flow-rate air (weak wind) is blown from the second and third air blowing ports 24b and 24c substantially vertically onto the guide member 47. In other words, the low-flow-rate air (weak wind) is blown from the second and third air blowing ports 24b and 24c onto the approaching transfer material 8 so as to press the transfer material 8 against the guide member 47.

As an example of the strong airflow from the first air blowing port 24a, blowing air of a high flow rate of at least 100 m/sec to paper of 80 g in weight (0.06 mm in thickness) is fundamentally preferable. For paper exceeding 80 g in weight (0.06 mm in thickness), a weak (low flow rate) airflow of less than 100 m/sec but equal to or more than 20 m/sec in wind velocity is sufficient for separating the paper from the intermediate transfer belt 4. In such a case, a weak wind as those from the second and third air blowing ports 24b and 24c may be blown also from the first air blowing port 24a.

According to the image forming apparatus 1 in the first example having the transfer material separating device 19 configured as described above, the transfer material separating air device 20 generates an airflow to blow a strong airflow from the first air blowing port 24a toward the separating position 4a, that is, in the direction of movement of the transfer material 8. Simultaneously, on both side portions of the transfer material 8 in the direction orthogonal or substantially orthogonal to the direction of movement of the transfer material, air is blown in the direction substantially orthogonal to the direction of movement of the transfer material 8. Therefore, the transfer material 8 is effectively separated by the blown air.

In this case, by separating reliably the distal end portion of the transfer material 8 at the above-described center portion of the transfer material 8, the strong airflow is allowed to enter a gap between the separated distal end of the transfer material 8 at the center portion and the intermediate transfer belt 4. Since the air entered into the gap at the center portion is hardly leaked therefrom, the distal end portion of the transfer material 8 is effectively separated from the intermediate transfer belt 4 from the center portion to the both side portions.

Also, by blowing the weak airflow from the second and third air blowing ports 24b and 24c onto the distal end portion of the approaching transfer material 8 in the direction substantially orthogonal to the direction of movement of the transfer material 8 at the both side portions of the transfer material 8 in the direction orthogonal or substantially orthogonal to the direction of movement of the transfer material, the distal end portion of the transfer material 8 is effectively and economically toward the guide member 47, that is, in the direction away from the intermediate transfer belt 4. Therefore, the transfer material 8 can be separated further effectively from the intermediate transfer belt 4.

In this manner, by differentiating the direction of blowing air from the first to third air blowing ports 24a, 24b, and 24c, even when the transfer material 8 can hardly be separated, separation from the intermediate transfer belt 4 is reliably achieved. Therefore, the transfer material 8 is prevented from moving with the intermediate transfer belt 4, and hence the transfer material 8 is reliably moved toward the transfer material belt carrier device 27 as a next transport position.

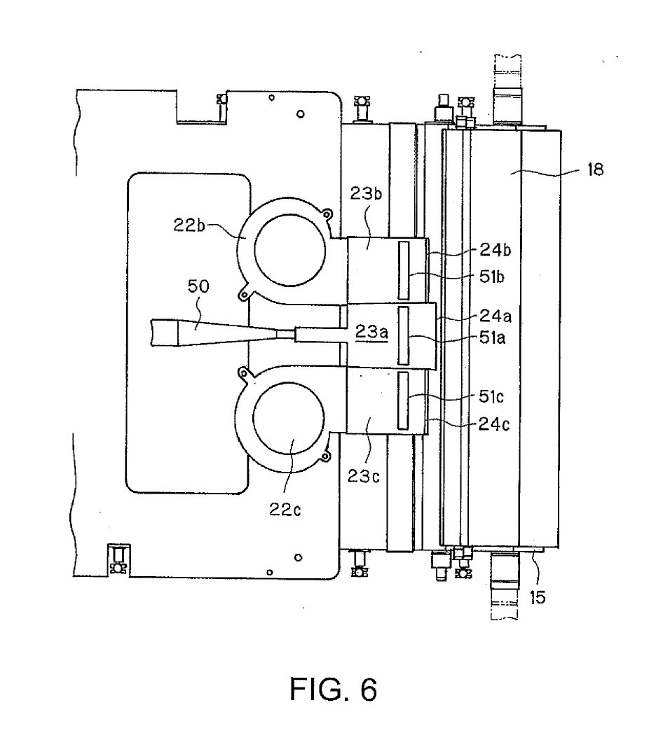

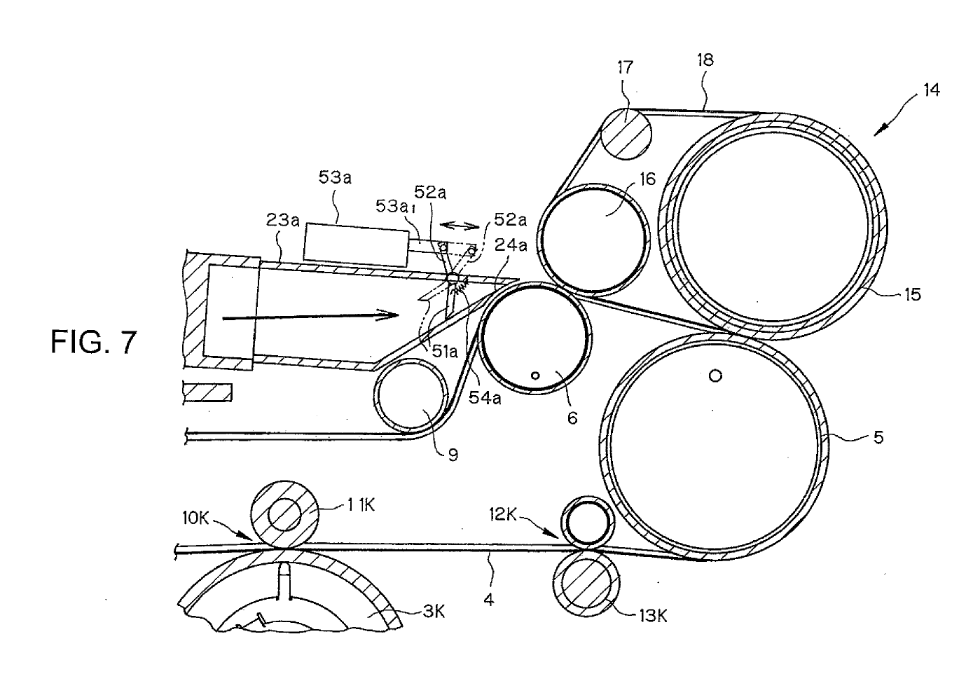

FIG. 6 is a drawing of an image forming apparatus according to a second example of the embodiment in the invention shown schematically and partly.

As shown in FIG. 6, in the image forming apparatus 1 in the second example, a first air control valve 51a is disposed in the first air duct 23a in the vicinity of the first air blowing port 24a. The first air control valve 51a controls the opening and closing of the first air blowing port 24a and controls the blow of air therefrom. A second air control valve 51b is disposed in the second air duct 23b in the vicinity of the second air blowing port 24b. The second air control valve 51b controls the opening and closing of the second air blowing port 24b and controls the blow of air therefrom. Furthermore, a third air control valve 51c is disposed in the third air duct 23c in the vicinity of the third air blowing port 24c. The third air control valve 51c controls the opening and closing of the third air blowing port 24c and controls the blow of air therefrom.

The first to third air control valves 51a, 52b, and 52c have the same configuration. Therefore, description is made only on the first air control valve 51a, and that for the second and third air control valves 51b and 51c is omitted.

As shown in FIG. 7, the first air control valve 51a is provided on the first air duct 23a so as to be capable of rotating between a closed position of the first air blowing port 24a indicated by a solid line and an opened position of the first air blowing port 24a indicated by a double-dashed line.

A first operation lever 52a is integrally and rotatably connected to the first air control valve 51a, and the first operation lever 52a is connected to a rod 53a₁ of a first solenoid 53a so as to be capable of rotating with respect to each other. Excitation of the first solenoid 53a is controlled by a control device. The first air control valve 51a is constantly urged toward the closed position of the first air blowing port 24a by a first return spring 54a.

In a normal state in which the transfer material 8 is not transported from a transfer material storage cassette (not shown), the first air control valve 51a is set to a closed position, and the first air blowing port 24a is closed. By the movement of the first air fan, a predetermined air pressure is constantly stored in the first air duct 23a on the opposite side from the first air blowing port 24a with respect to the first air control valve 51a. In this case, the predetermined air pressure is set to a pressure which achieves a stable blow of strong airflow having a desired amount of airflow from the first air blowing port 24a immediately after the first air control valve 51a is opened. In the second and third air ducts 23b and 23c, a predetermined air pressure which is lower than the air pressure in the first air duct 23a is constantly stored respectively. Therefore, a weak airflow of a predetermined amount of airflow is stably blown respectively from the second and third air blowing ports 24b and 24c immediately after the second and third air control valves 51b and 51c are opened. Accordingly, separation of the distal end of the transfer material by the blowing of the air is achieved further reliably and efficiently.

Other configurations and effects and advantages of the image forming apparatus 1 in the second example are the same as those in the first example.

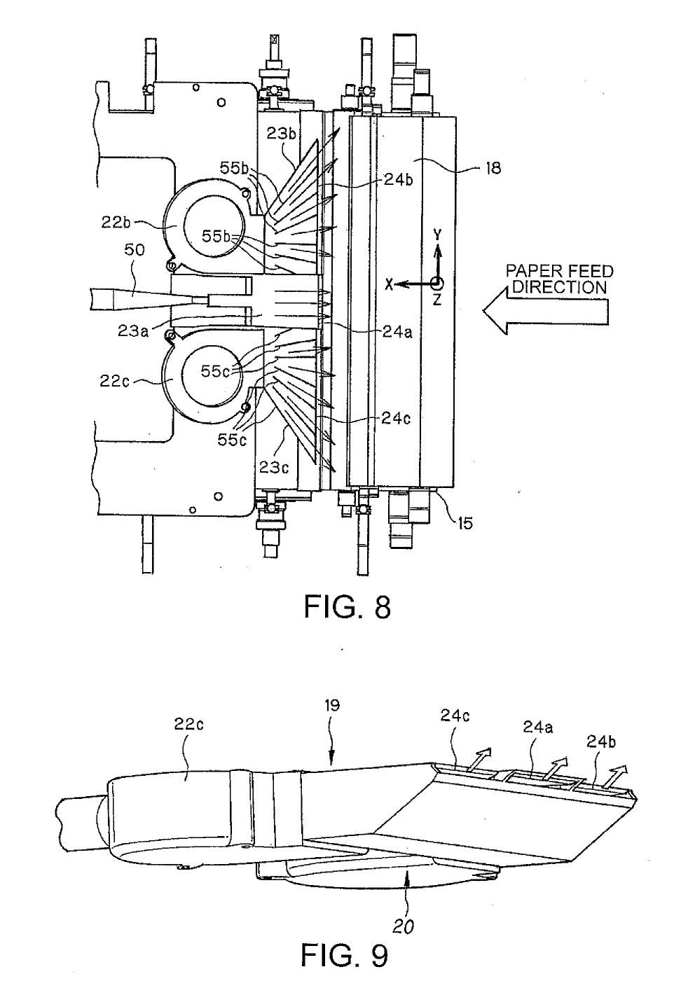

FIG. 8 is a drawing of the image forming apparatus according to a third example of the embodiment in the invention showing schematically and partly.

In the first and second examples described above, air is blown from the first to third air blowing ports 24a, 24b, and 24c in the direction opposite from the direction of transport of the transfer material 8 (paper-feed direction) and in the upward direction. In other words, air is blown from the first to third air blowing ports 24a, 24b, and 24c in the direction opposite from the direction X, which is the paper-feed direction, and upward in the direction Z which is orthogonal to a plane of the transfer material 8. In contrast, as shown in FIG. 8, in the image forming apparatus 1 in the third example, air is blown from the second and third air blowing ports 24b and 24c in the direction Y, which is orthogonal to paper feed direction in the plane of the transfer material 8, in addition to the direction X as the paper-feed direction and the direction Z. In this case, the direction of air in the direction Y is set as follows.

In other words, a predetermined number of (six in the example shown) second partitioning panels 55b are provided in the second air duct 23b, and the same number of small air channels are formed. In this case, the innermost second partitioning panel 55b is provided so as to face inward (the side of the first air blowing port 24a). Then, the respective second partitioning panels 55b are provided so as to face outward (the opposite side from the first air blowing port 24a) little by little from the inner side along the direction Y. Accordingly, air is blown from the second air blowing port 24b in the direction X (opposite from the paper-feed direction) and in the direction Z (upward) in a fan-shape (widening toward the distal end) along the direction Y.

In the same manner, a predetermined number of (six in the example shown) third partitioning panels 55c are provided in the third air duct 23c as well, and the same number of small air channels are formed. In this case, the respective third partitioning panels 55c and the respective second partitioning panels 55b of the second air duct 23b are symmetry about a center axis of the first air duct 23a. Accordingly, air is blown from the third air blowing port 24c in the direction X (opposite from the paper-feed direction) and in the direction Z (upward) in the fan-shape (widening toward the distal end) along the direction Y. The air blown in the direction Y from the third air blowing port 24c and the air blown from the second air blowing port 24b in the direction Y is symmetry about the center axis of the first air duct 23a.

According to the image forming apparatus 1 in the third example, the air is blown from the second and third air blowing ports 24b and 24c in the direction Y as well in the fan-shape in addition to the direction X and the direction Z. Accordingly, the center portion in the direction (the direction Y) orthogonal to the direction of transport of the distal end portion of the transfer material 8 is separated by the strong airflow from the first air blowing port 24a. Then, when the center portion at the distal end portion of the transfer material 8 is separated once, even when the blowing of the strong airflow from the first air blowing port 24a is stopped, the distal end portion of the transfer material 8 is effectively separated from the intermediate transfer belt 4 by the airflow in the direction Y in addition to the airflow in the direction X and the direction Z of the weak airflow blown from the second and third air blowing ports 24b and 24c. In addition, when the center portion of the distal end portion of the transfer material 8 is separated once, blowing of the strong airflow from the first air blowing port 24a is stopped, and hence an image formed at the center portion of the transfer material 8 in relatively many cases is prevented from being affected by the strong airflow.

Other configurations and other effects and advantages of the image forming apparatus 1 in the third example are the same as those in the first example.

FIG. 9 is a perspective view showing a transfer material separating air device in the image forming apparatus used in a fourth example of the embodiment of the invention.

In the first example shown in FIG. 2 described above, the amount and direction of airflow blown from the first air blowing port 24a are different from the amount and direction of airflow blown from the second and third air blowing ports 24b and 24c. In contrast, as shown in FIG. 9, in the image forming apparatus 1 in the fourth example, the amount of airflow blown from the first to third air blowing ports 24a, 24b, and 24c are set to the same weak airflow. The directions of airflow blown from the first to third air blowing ports 24a, 24b, and 24c are also set to the same direction. The transfer material separating air device 20 in the fourth example is effective for the image forming apparatus 1 in which only the transfer material which can be separated only by the above-described weak airflow is used.

Other configurations and other effects and advantages of the image forming apparatus 1 in the fourth example are the same as those in the first example. It is also applicable to set the directions of air blown from the first to third air blowing ports 24a, 24b, and 24c in the same direction and differentiate the amount of air.

The invention is also applicable, for example, to an image forming apparatus which does not have the intermediate transfer belt 4, and employs liquid developer, in which toner images on the respective photoconductors 3Y, 3M, 3C, and 3K, that is, on the latent image carrier members are transferred directly to the transfer material 8. In this case, the transfer member separating device is adapted to separate the transfer material from the latent image carrier members. Therefore, the latent image carrier members in this case constitute the transfer material moving member and the liquid developer image carrier member in the invention. Also, the backup rollers (which correspond to the backup rollers 11Y, 11M, 11C, and 11K in the examples described above) which bring the transfer material into press contact with the latent image carrier members constitute the transfer member in the invention.

The invention is also applicable to a four-cycle image forming apparatus. Furthermore, the invention is also applicable to an image forming apparatus which employs liquid developer of a single color.

The transfer material separating device in the invention is not limited to separation of the transfer material discharged from the transfer nip portion from the fixing member (ex. fixing roller), but may be applied to separation of the transfer material discharged from a fixing nip portion of the fixing device from the fixing member (fixing roller or the like). In this case, the transfer material separating device is provided in the vicinity of the terminal of the fixing nip portion on the downstream side in the direction of transport of the transfer material.

The invention may be applied to the transfer material separating device of any type within the scope of appended claims as long as it is a device adapted to separate the transfer material from a transfer material transport device.

The entire disclosure of Japanese Patent Application Nos: 2008-16084, filed Jan. 28, 2008 and 2008-259490, filed Oct. 6, 2008 are expressly incorporated by reference herein.

What is claimed is:

1. A transfer material separating device comprising:
a transfer material separation air blower unit that blows air to a transfer material moving together with a transfer material moving member and separates the transfer material from the transfer material moving member, wherein
the transfer material separation air blower unit includes:
a first blowing unit that blows air toward a center portion of the transfer material in a direction orthogonal or substantially orthogonal to a direction of movement of the transfer material, and
a second blowing unit that blows air in the direction substantially orthogonal to the direction of movement of the transfer material to side portion of the transfer material in the direction orthogonal or substantially orthogonal to the direction of movement of the transfer material.

2. The transfer material separating device according to claim 1, wherein
the transfer material separation air blower unit includes:
an airflow generating unit that generates an airflow to be blown on the transfer material,
a first airflow duct to be connected to the airflow generating unit and connected to the first blowing unit, and
a second airflow duct to be connected to the airflow generating unit and connected to the second blowing unit.

3. The transfer material separating device according to claim 2, further comprising:
a third blowing unit that blows air in the direction substantially orthogonal to the direction of movement of the transfer material,
a third airflow duct disposed on a side opposite from the second airflow duct in the direction orthogonal or substantially orthogonal to the direction of movement of the transfer material in a plane of the transfer material so as to be adjacent to the first airflow duct and connected to a third blowing unit.

4. The transfer material separating device according to claim 3, wherein
the airflow generating unit includes:
a first fan to be connected to the first airflow duct,
a second fan to be connected to the second airflow duct, and
a third fan to be connected to the third airflow duct.

5. The transfer material separating device according to claim 3, comprising:
a first airflow control valve disposed in the first airflow duct,
a second airflow control valve disposed in the second airflow duct, and
a third airflow control valve disposed in the third airflow duct.

6. The transfer material separating device according to claim 1, wherein
a flow rate of the airflow from the first blowing unit is higher than a flow rate of the airflow from the second blowing unit.

7. A transfer device comprising:
a transfer unit that moves a transfer material together with a liquid developer image carrier member to transfer an image to the transfer material; and
a transfer material separating unit configured to separate the transfer material to which the image is transferred from the carrier member, wherein
the transfer material separating unit includes:
a transfer material separation air blower unit that blows air to a distal end portion of the transfer material approaching with the liquid developer image carrier member and separates the distal end portion of the transfer material from the liquid developer image carrier member,
the transfer member separation air blower unit includes:
a first blowing unit that blows air toward a center portion of the transfer material in a direction orthogonal or substantially orthogonal to a direction of movement of the transfer material, and
a second blowing unit that blows air in the direction substantially orthogonal to a direction of movement of the transfer material on the side portions of the transfer material in the direction orthogonal or substantially orthogonal to the direction of movement of the transfer material.

8. The transfer device according to claim 7, wherein
the transfer material separating unit blows an airflow between a contact surface of the transfer material with respect to the liquid developer image carrier member and the image carrier member.

9. An image forming apparatus comprising:
a latent image carrier member that carries an latent image;
a developing unit that develops the latent image with liquid developer including toner and carrier liquid and forms an image on the latent image carrier member;
a transfer medium that is transferred the image,
a first transfer unit that transfers the image on the latent image carrier member to the transfer medium;
a second transfer unit that transfers the image transferred to the transfer medium to a transfer material; and
a transfer material separation air blower unit that blows air to the transfer material moving together with the transfer medium and separates the transfer material from the transfer medium,
wherein the transfer material separation air blower unit includes:
a first blowing unit that blows air toward a center portion of the transfer material in a direction orthogonal or substantially orthogonal to a direction of movement of the transfer material, and
a second blowing unit that blows air in the direction substantially orthogonal to the direction of movement of the transfer material to side portion of the transfer material in the direction orthogonal or substantially orthogonal to the direction of movement of the transfer material.

10. The image forming apparatus according to claim 9, wherein the transfer material separation air blower unit includes:
an airflow generating unit that generates an airflow to be blown on the transfer material,
a first airflow duct to be connected to the airflow generating unit and connected to the first blowing unit, and
a second airflow duct to be connected to the airflow generating unit and connected to the second blowing unit.

11. The image forming apparatus according to claim 10, further comprising:
a third blowing unit that blows air in the direction substantially orthogonal to the direction of movement of the transfer material,
a third airflow duct disposed on a side opposite from the second airflow duct in the direction orthogonal or substantially orthogonal to the direction of movement of the transfer material in a plane of the transfer material so as to be adjacent to the first airflow duct and connected to the third blowing unit.

12. The image forming apparatus according to claim 11, wherein the airflow generating unit includes:
a first fan to be connected to the first airflow duct,
a second fan to be connected to the second airflow duct, and
a third fan to be connected to the third airflow duct.

13. The image forming apparatus according to claim 11, comprising:
a first airflow control valve disposed in the first airflow duct,
a second airflow control valve disposed in the second airflow duct, and
a third airflow control valve disposed in the third airflow duct.

14. The image forming apparatus according to claim 9, wherein a flow rate of the airflow from the first blowing unit is higher than a flow rate of the airflow from the second blowing unit.
